(19) United States
(12) Patent Application Publication
(10) Pub. No.: US 2005/0023779 A1
(43) Pub. Date: Feb. 3, 2005

(54) Variable resistance tracton sled for skaters

(76) Inventor: Douglas Charles Kalvelage, Independence, MO (US)

Correspondence Address: DOUGLAS C. KALVELAGE, 4317 HUNTINGTON WAY, INDEPENDENCE, MO, 64055, US

(21) Appl. No.: 10/876,054

(22) Filed: Jun. 24, 2004

Related U.S. Application Data
(60) Provisional application No. 60/483,038, filed on Jun. 26, 2003.

(51) Int. Cl. B62B 13/00

(52) U.S. Cl. 280/19; 280/1.5

(57) ABSTRACT

A sled type device consisting of a rigid platform 16 supported by a multitude of flexible filaments 18A, 18B, 18C and 18D. It is pulled by a skater for strengthening purposes. The filaments are attached to the platform in a way that causes downward pressure to vary the number of filaments touching the skating surface. The skater is connected to the sled by a rope and pulley harness that effectively eliminates sideways forces from being transmitted by the skater to the sled.

### CROSS-REFERENCE TO RELATED APPLICATIONS

Provisional Patent Application 60/483,038

### FEDERALLY SPONSORED RESEARCH

Not Applicable

### SEQUENCE LISTING OR PROGRAM

Not Applicable

### BACKGROUND OF THE INVENTION

1. Field of Invention

This invention relates to sled type resistance training devices used by skaters.

2. Background of the Invention

For years, in an effort to improve speed, professional strength and conditioning coaches have had their athletes train against a resistance. Training against a resistance improves an athlete's power, which is one of the components of improved speed. Some commonly used methods of resistance are: uphill running, pushing a sled (football players), pulling or pushing a fellow athlete (or coach) who they are connected to, pulling a weighted tire (or metal sled) across a field or track, running or skating while wearing a parachute type device. Strength and conditioning coaches have also learned over the years how important specificity is to athletic training.

It was once believed that generic muscle development (similar to what body builders do) was the key to improved power and speed for all athletes. Eventually studies confirmed that movement strengthening (the actual specific movements experienced during an athletic contest) is more beneficial than simple muscle enlargement. What most strength and conditioning coaches now agree upon is this: The closer an athlete's restricted (strengthening) workouts mimic his/her actual athletic movements, the greater will be their functional power and speed. Generic muscle enlargement is out. Specific movement strengthening is in.

What does this mean for a skater (hockey player) trying to improve their power and speed? It means a skater can do all the running and weightlifting he wants, but that won't do as much good as restricted skating. To strengthen their skating movements, skaters (hockey players) have made use of parachute type devices (wind resistance), pulled a fellow skater or coach around the ice, or pulled a homemade sled type device (i.e. a piece of plywood loaded with cinder blocks or an old tire filled with bricks) across the ice.

There are a number of disadvantages with these methods:
(a) Parachutes are dangerous in crosswinds, causing skaters to lose their balance. They don't work at slow speeds. They become easily entangled. Numerous parachutes are required for varying amounts of additional resistance. They are usually used indoors under closely monitored conditions. They don't work while skating in a tight circle.
(b) Pulling or pushing a fellow skater around the ice is haphazard at best, because there is no way to reliably measure the resistance being experienced by the skater. Also, and obviously, a skater needs a partner.
(c) A skater pulling/dragging a dead weight (typically an old tire filled with bricks inside or a piece of plywood loaded with cinder blocks) is wholly unsatisfactory for a number of reasons. First of all, the inability to control the dead weights' momentum makes it dangerous. A skater pulling a dead weight (typically one end of a length of rope or chain is attached to the weight and the other end is wrapped around the skater's waist) will experience the restriction of the weight when he commences skating. If the skater slows down even for an instant (muscle fatigue), the dead weight is no longer a restriction but becomes dead momentum sliding across the slippery ice toward the skater. This occurs not only when a skater slows down even for a brief moment, but is especially so when the skater comes to a stop (typically, the end of the skating rink). Skaters using this type of training device have to constantly guard against being run into and injured by the weight they are pulling. This lack of momentum control becomes especially troublesome with increasing amounts of weight. The more dead weight a skater attempts to pull, the more dangerous the weight becomes when the skater slows or stops.

The second reason pulling a dead weight doesn't work very well is because of centrifugal force. Most skaters (especially hockey players), need to skate on a curve (circular). Skating in a circle while pulling a dead weight quickly becomes counter-productive because the centrifugal force on the moving weight will quickly send the weight off course from the direction the skater is attempting to skate—in a circle. In no time at all, the dead weight is pulling the skater instead of the other way around. The more weight a skater attempts to pull, the worse the centrifugal force.

The third reason a skater a pulling a dead weight across ice is unsatisfactory is fishtailing. The skating motion is not completely linear like running. A runner propels himself forward with his hips, legs, feet, and arms all moving in a straight line, in a single plane. A skater on the other hand, propels himself forward by pushing side to side. The hips of a runner move in a straight line with the direction of travel. The hips of a skater move side to side to the direction of travel. These sideways forces are typically transferred from the hips of the skater through a single strand of rope or chain back to the dead weight causing the weight to fishtail side to side. This fishtailing action adversely effects the skater's ability to maintain proper form and technique and thus becomes detrimental.

A skater pulling an object (weighted sled type device) can gain increased strength from the resistance the additional weight creates. Unfortunately, all current sled type devices become essentially uncontrollable when set in motion on ice. That is why sled type devices are used infrequently and alternative devices are favored-pulling a fellow skater or coach, a mini-parachute, etc.

### OBJECT AND ADVANTAGES

My sled solves the problem of dangerous and uncontrollable sleds. My sled type device incorporates a platform supported by a multitude of angled flexible filaments, which connect to a skater with a self-adjusting triangulating type harness. This type of construction has a number of advantages. First, the resistance experienced by the skater originates not just from the sled's weight itself but from the traction and grip the filaments have with the ice. Ice by its nature is very slippery. Conventional sleds do not grip or get a hold of the ice; consequently they slide easily across the ice. Because of the way my sled is constructed, not all of the filaments are in contact with the skating surface at the same time. If the sled doesn't have much weight to it, then only a relatively few number of filaments will be touching the skating surface thereby creating a relatively small amount of resistance.

The number of filaments in contact with the ice (traction) will largely determine the amount of resistance the skater experiences—not just the weight of the sled alone. Because of the flexibility of the filaments and their angle, the greater the sled's total weight, the more the sled is pressed downward resulting in greater filament contact with the ice which creates more traction. In essence, there is a proportional relationship between the sled's total weight and the number of filaments (resistance) contacting the ice. This means the skater can now pull something that has a self-adjusting amount of traction on the skating surface and results in a sled that will slow itself when the skater slows and/or stops when the skater stops. My sled has a built-in way to control its speed because it has built-in traction. The sled is gripping the ice rather than merely slipping easily across it. No longer does the skater have to worry about getting run into by a runaway sled.

Another advantage of my sled's construction is the way in which it counteracts centrifugal force. Because the filaments contact the skating surface at an angle, they are pushing against any sideways force created by the natural sideways movement of the skating stride. Hockey players in particular spend a great deal of time skating on a curve (circular skating). Attempts to strengthen circular skating movements with a conventional sled type device on ice are in most cases futile. Since the weighted device has no proper way to grip the ice, the centrifugal forces acting upon it that are created by a skater moving in a circle soon causes it to go off course and not follow circularly behind the skater. This usually results in the sled pulling the skater off course rather than the skater pulling the sled in a circle. My sled tracks circularly behind the skater because it has traction and grips the ice like car tires on pavement. Because the filaments are able to self-adjust to the sled's total weight, the sled can have a proportionally greater or lesser amount of traction.

Another advantage of my sled is its ability to track in a straight line without fishtailing behind the skater. My sled's filaments contact the ice at an angle. The starboard (right) side filaments angle down and out. The port (left side) filaments angle down and out. The starboard side filaments will tend to push the sled left. The port side filaments will tend to push the sled right. This results in a sled that doesn't want to go left or right but tends to track straight ahead. (As a comparison, Special Olympic wheelchair athletes use wheelchairs with wheels that angle out at the bottom to facilitate straight line tracking.) A sled that doesn't track straight and true is detrimental to a skater because it can alter proper technique.

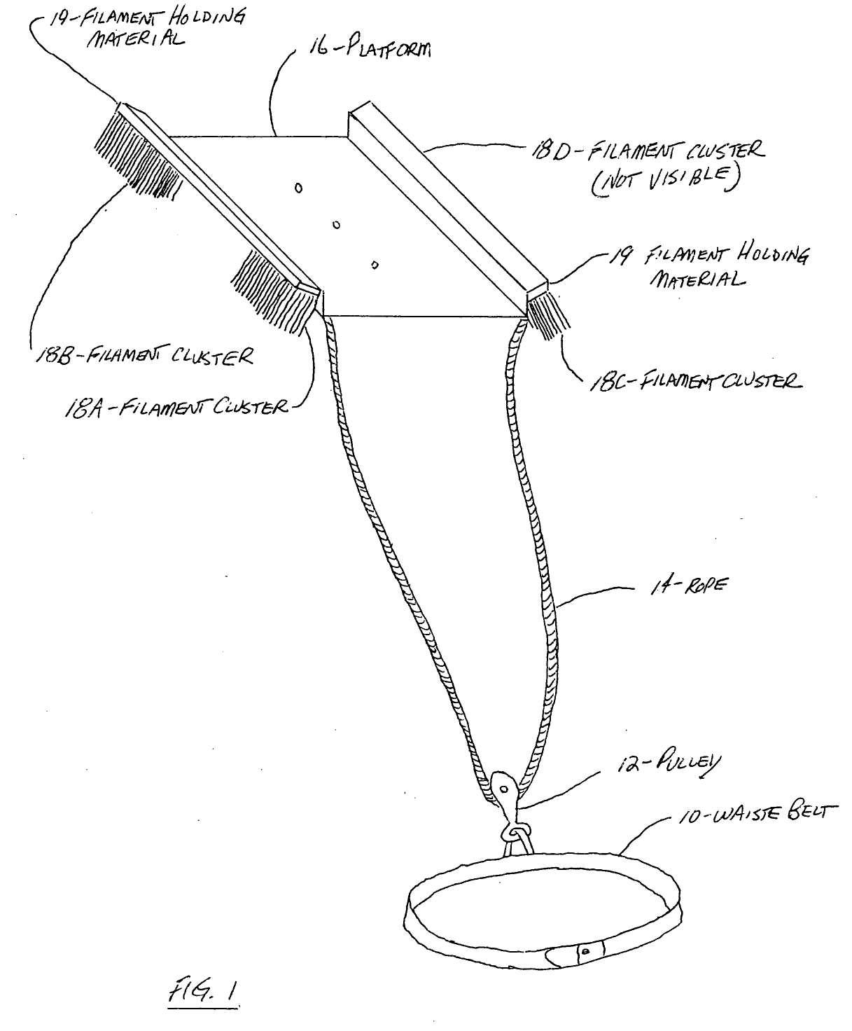

In addition to the sled's port/starboard filament arrangement, the sled's pulling apparatus also contributes to straight-line travel and a reduction in the previously mentioned fishtailing. The pulling apparatus, here referred to as the waist belt harness, consists of an adjustable waist belt, a pulley that is attached to the waist belt and a length of rope (or other suitable material) that loops around the pulley and connects to the sled forming a long skinny triangle (see FIG. 1). During use, the skater's hips will be moving from side to side as previously mentioned. As the skater pushes with his right leg, his hips will move left (to port). This causes the left side of the triangle (left side of the rope) to shorten while the right side correspondingly lengthens. When the skater then pushes out with his left leg, his hips will move to the right (starboard). This now creates a reverse sequence—the right half of the rope shortens while the left half correspondingly lengthens. As the skater moves forward, a constant shortening and lengthening will occur to each side of the rope. This constant shortening and lengthening process effectively eliminates sideways forces being transmitted from the skater's hips to the sled. With virtually no sideways forces acting upon it, the sled is free of fishtailing and will track in a straight line behind the skater.

### SUMMARY

In accordance with the present invention, a filament supported platform, a multitude of flexible filaments angling out from the platform such that not all filaments touch the skating surface simultaneously except when their resistance to deflection is exceeded by the platform's total weight, and a variable length triangulating pulling harness.

### DETAILED DESCRIPTION—FIGS. 1,2,3, AND 4—PREFERRED EMBODIMENT

FIG. 1 shows a isometric view of my variable resistance traction sled for skaters. In the foreground is an adjustable waist belt 10. The belt 10 is made of nylon seatbelt material with an adjustable buckle. Other materials such as leather can also be used. Attached to the outside of the belt approximately half way around the belt is a pulley 12. The preferred embodiment uses a metal pulley 12. Other pulleys made from plastic or a combination of metal and plastic will also work. A length of ¼″ solid braided nylon rope approximately 15 feet long loops around the pulley forming a long skinny triangle shape with the front of a platform 16. The two sides of the triangle shape formed by the rope are approximately 7½ feet long. The rope ends are attached to the front of the platform with knots or clip-on type hardware (not shown). The platform 16 is rectangular in shape, having two short sides (front end and the back end) and two longer formed sides (port and starboard) and measures approximate 16 inches×24 inches. The platform 16 is made of aluminum approximately 3/16″ thick. Along the lengthwise centerline are a series of small holes which facilitate the addition of weight plates (not shown).

Attached to each of the long sides of the platform is a plastic filament holder 19. On each end of each filament holder 19 is a cluster of wire filaments 18A, 18B, 18C and 18D. The wire filaments are made of flat steel wire approximately ⅛″ wide and 7″ long. Each filament cluster 18A, 18B, 18C and 18D contains approximately 100 wire filaments angled outward approximately 20 degrees.

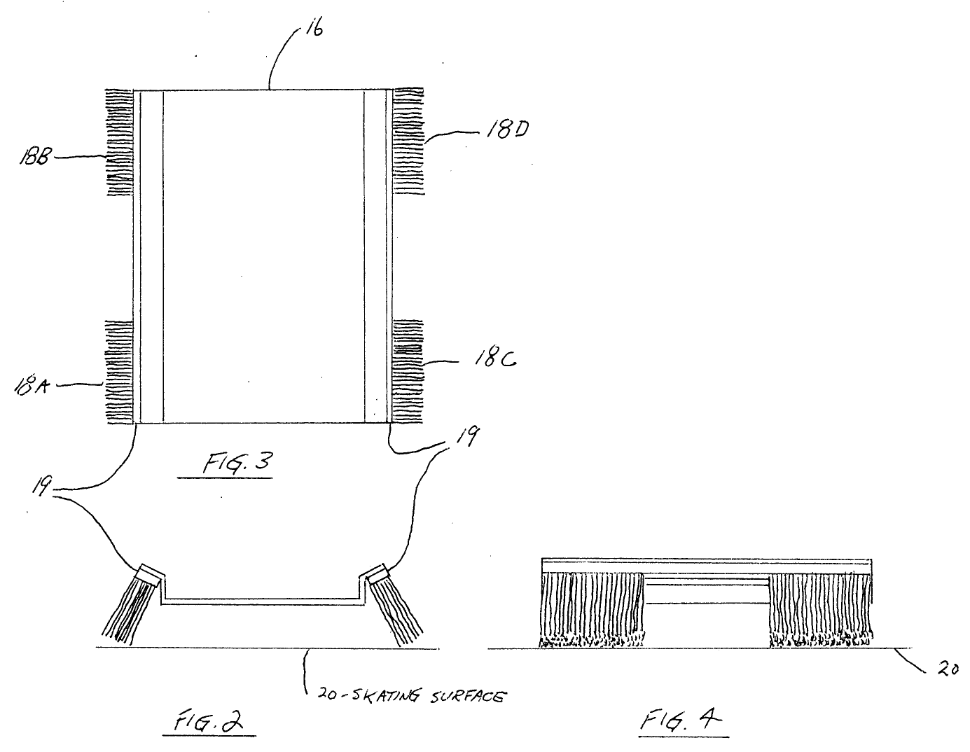

FIGS. 2, 3, and 4 show three different views of the preferred embodiment of the platform 16 with attached filament holders 19 and filament clusters 18A, 18B, 18C and 18D. FIG. 2 is an end view that shows the filament clusters resting on a skating surface 20. FIG. 3 is a top view. FIG. 4 is a side view showing the filament clusters resting on the skating surface 20.

Operation—FIGS. 1, 2, 3, and 4

The manner of using my variable resistance traction sled is similar to the use of other resistance sled type devices in that it is dragged by a skater. The skater connects the belt 10 loosely around his waist. He proceeds to skate. As he strides forward (or backward if he is trying to strengthen his backward skating movements), his hips will, in addition to moving forward, be moving from side to side. The rope 14 will tighten and the filament supported platform 16 will begin to move forward in the direction of the skater. Since the skater is connected to the sled (platform 16 and the attached filaments) by a self-adjusting rope, the left (port) half length of rope will shorten. The right (starboard) half-length of rope will lengthen a corresponding amount. The skater's next stride reverses the direction of his hips. As his hips move to the right, the left half length of rope will lengthen and the right half length of rope will shorten. This process of shortening and lengthening repeats itself over and over as the skater strides forward. If the skater was connected to the sled with only a single solid strand of rope (or chain), then the sideways movement of the skater's hips would cause the sled to be jerked from side to side. The sideways jerking of the sled would cause the sled to fishtail and severely disrupt the skater's technique. The repeated shortening and lengthening of the two sides of the rope 14 negates the sideways forces caused by the hips moving from side to side. This elimination of sideways forces being transmitted to the sled allows it to track in a straight line behind the skater.

As the skater moves forward, the metal filaments shown in FIGS. 2, 3 and 4 that are in contact with the skating surface 20 will begin to flex and create microscopic scratches in the ice. This process creates resistance to movement, which helps the skater strengthen his skating movements. FIG. 2 shows that only a small percentage of the total number of filaments will be touching the ice. When the skater adds weight to the platform though, the platform will be pressed down closer to the ice because the filaments are flexible. As the platform is pressed closer to the ice, additional filaments will make contact with the ice. This then creates additional microscopic scratching which creates additional resistance. The more additional weight, the more downward pressure and filament flex. The more downward pressure, the more filament to surface contact. The more filament to surface contact, the more resistance. The skater has the ability to vary the sled's resistance by how much weight is added or removed from the platform.

It should be pointed out that the filaments will be flexing in primarily two directions. They will be flexing primarily outward from downward force. Also, they will be flexing backward (creating resistance) as the sled is dragged forward. The microscopic scratches created by the filaments, the filament's resistance to deflection (bendability) and the total downward pressure of the platform all working together create traction. This traction (which is absent from homemade or commercial sled type devices) is what makes my sled so safe and controllable on ice. For example, let's say a skater is pulling my sled and he decides to stop. This means the forward force acting upon the sled is reduced to zero. With no forward force acting upon the sled, the filaments, which were being flexed backward, are now free to flex forward. By flexing forward, the filaments create backward force, which slows the sled and helps bring it to a stop. This type of sled construction means my sled has a built-in resistance to movement-either forward or centrifugally. A skater using my sled is being resisted by not just the weight of the sled, but by the filament's resistance to deflection (bendability), the total number of filaments being deflected and the microscopic scratching occurring to the ice surface.

As the skater moves forward, the filaments 18A, 18B, 18C and 18D will be creating microscopic scratches to the skating surface. It is very important that the scratches be microscopic. Microscopic scratches, regardless of number, are acceptable to a skating rink owner and the skater(s) using the sled. If the sled created gouges and grooves in the ice, rather than microscopic scratches, not only would the ice be seriously degraded and torn apart, but skaters would be greatly susceptible to loss of balance injuries. Because the platform 16 is supported by a multitude of filaments, each filament bears only a fraction of the total load. Furthermore, since the filaments are flexible and not rigid, they are less likely to deeply penetrate the surface of the ice. These two factors, multiplicity and flexibility, result in a sled that is gentle on the ice, which is acceptable to skating rink owners and skaters.

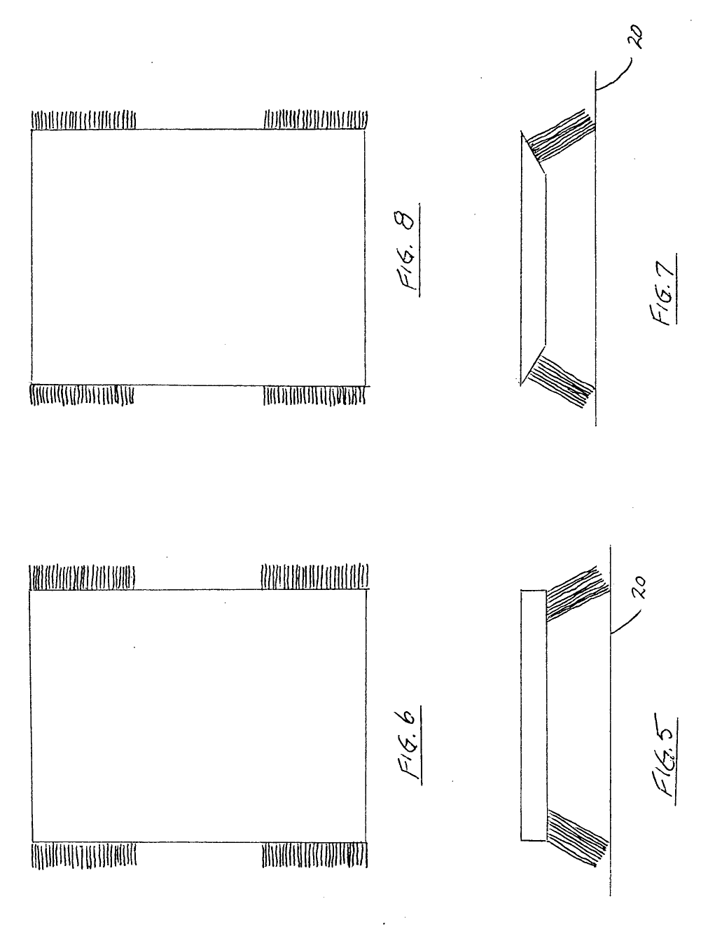

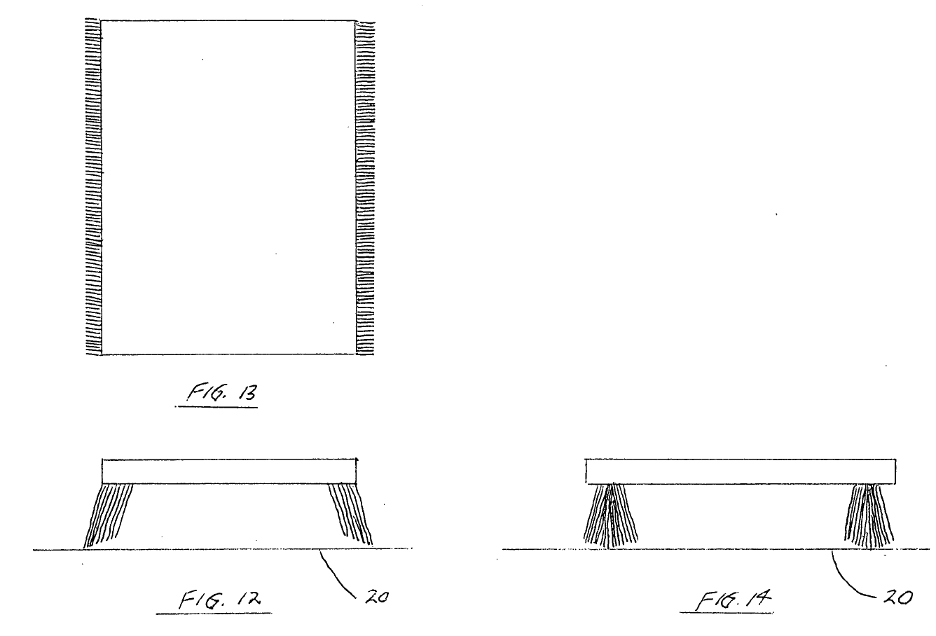

FIGS. 5, 6, 7, 8, 9, 10, 11, 12, 13, and 14 show alternative embodiments of my variable resistance traction sled. Unlike FIG. 2, which shows the filaments attached to a holder that is connected to a formed metal platform, the filaments in FIG. 5, are connected directly to a flat platform. Even though attached differently, both views show that only a relatively few number of filaments are touching the skating surface 20.

FIGS. 5, 7, and 12 show end views of different embodiments. In all three cases not all the filaments are touching the skating surface 20 at the same time.

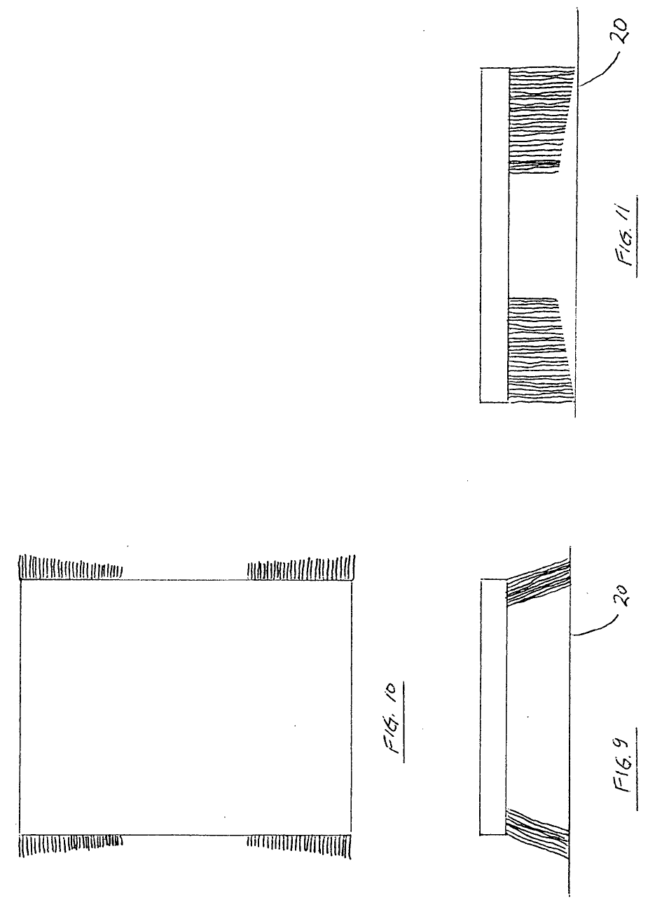

FIG. 9 appears to show all the filaments touching the skating surface 20 at the same time. The top view (FIG. 10) and the side view (FIG. 11) show otherwise. These two views (plus the FIG. 9 view) clearly show a platform that is supported by filaments that are angled outward, but not all are touching the skating surface at the same time.

While the preferred embodiment shown in FIGS. 1, 2, 3, and 4 is made of formed metal, the alternative embodiments shown in FIGS. 5, 6, 7, 8, 9, 10, 11, 12, 13, and 14 are made of plastic, wood, metal, or other material suitable for holding filaments.

FIGS. 3, 6, 8, and 10 show top views of the filaments clustered at the corners of their respective platforms. FIG. 13 shows a top view of the filaments being clustered in a row along both the left and right sides.

The top views of all embodiments show a rectangular shape to the platform. Other geometric shapes can be used as long as the supporting filaments do not all touch the skating surface at the same time and provision is made to create the long skinny triangle shape that is formed by the sides of the rope and the line between the rope's two points of connection with the sled.

FIG. 1 shows the rope 14 looping around the pulley. Chain, flexible wire cable, and shock cord (bungee) can also be used.

The filaments described in the preferred embodiment use flat steel wire about 7″ long. Round wire can be used as well. Synthetic filaments can be substituted for wire when the sled is used off-ice with inline or roller skates.

The preferred embodiment utilizes approximately 400 total strands of flat steel wire approximately 7″ in length and ⅛″ wide. Other lengths of filaments and total number of filaments will also work. Proper performance of the sled is also dependent on the flexibility of the filaments. A thicker (larger cross-section) filament that is long enough, will have the same relative bendability as a short thin filament. Likewise, a very lightweight sled (platform plus added weight) would require a fewer number of filaments to provide support than a sled (platform plus added weight) that is substantially heavier.

The preferred embodiment shows the filaments angled outward approximately 20 degrees. Depending on the filament's stiffness, length and quantity, other angles can also be utilized. Practically speaking a long stiff filament set at 35 degrees will yield approximately the same amount of support as a short soft filament set at 12 degrees.

All embodiments shown utilize filaments of uniform thickness and stiffness. For special situations though, a platform can be supported by filaments of varying thickness and stiffness. Because not all ice (skating surfaces) has the same hardness and texture, my sled can be built with filaments of varying type, length, quantity, and configuration so as to create the proper amount of traction and resistance needed by the skater.

While my above description contains many specificities, these should not be construed as limitations on the scope of the invention, but rather as an exemplification of one preferred embodiment thereof. Many other variations are possible. Accordingly, the scope of the invention should be determined not by the embodiment(s) illustrated, but by the appended claims and their legal equivalents.

1. A method for puffing a sled type resistance device across a skating surface comprising a filament supported platform and a connecting harness whereby said device's resistance, momentum and direction of travel are effectively controlled.
